(19) United States
(12) Patent Application Publication
(10) Pub. No.: US 2003/0061260 A1
(43) Pub. Date: Mar. 27, 2003

(54) Resource reservation and priority management

(75) Inventor: Ragunathan Rajkumar, Monroeville, PA (US)

Correspondence Address: David J. Thibodeau, Jr., HAMILTON, BROOK, SMITH & REYNOLDS, P.C., Two Militia Drive, Lexington, MA, 02421-4799, US

(73) Assignee: TimeSys Corporation, Pittsburgh, PA

(21) Appl. No.: 09/962,925

(22) Filed: Sep. 25, 2001

(51) Int. Cl. G06F 9/00

(52) U.S. Cl. 709/104; 709/103

(57) ABSTRACT

A method for resource management in a real-time data processing system. Multiple tasks having potentially different resource data processing resource requirements are scheduled to run concurrently. A first subset of tasks are defined as reservation activities, each having specified parameters for determining priority among other reservation activities. Specified reservation activity parameters may include a resource consumption amount, execution time period, deadline, start time and/or reservation lifetime. The system also supports resource allocation among fixed-priority activities, such as may be legacy interrupt-driven or operating system tasks. The fixed-priority activities may themselves have fixed priorities with respect to other fixed priority activities. The fixed priority activities may themselves execute importantly at collective priority which is less than those allocated for at least one of the reservation activities. The co-existence of fixed-priority activities with reserves is also applicable to dynamic-priority activities. Finally, reservations can be created inside parent reservations.

### BACKGROUND OF THE INVENTION

The problem of resource management occurs in many different aspects of data processing systems. In the typical scenario, a resource manager such as may be implemented as part of a operating system must schedule access to various shared resources, including processing cycles of the central processing unit (CPU), disk drive bandwidth, access to shared network connections, and access to other peripheral devices.

Operating Systems (OS), and more particularly, schedulers that run in some is kernel mode of the OS are commonly employed to provide protected access to system resources, typically on some type of time-shared basis. This canonical time-sharing model has been used in computing systems for almost four decades. But in many applications, the need for access to different resources are in general are not completely independent of one another. As a result, situations develop where guaranteed access of one resource disrupts the state of another resource, thereby giving rise to scheduling conflicts.

For example, a task that runs a multimedia application may require sending real-time data across a network connection, and therefore demands a certain amount of network bandwidth to be reserved in the system. A traditional network connection scheduler may involve queuing of data packets. But the application task itself also needs to be granted enough CPU time in order to cause an adequate number of packets to be supplied to the queue. This comes at the expense of a significant number of processor cycles in both the user space task and the system space. Consequently, proper scheduling requires processing guarantees for both the application that generates the data, as well as the packet scheduler that is physically responsible for transmitting the packets over the network connection. The failure to adequately allocate resources to both tasks results in a less than optimum use of resources, and in a worst-case scenario, a dysfunctional system.

On the other hand, a task that primarily receives data from a network connection typically requires more processor-centric resources. A receiving process typically does not have much control on the number of packets arriving on its network connection. However, it certainly can control distribution processing of these packets in order to provide guaranteed service to various applications with different timing constraints.

Unfortunately, traditional operating systems in widespread use, such as Linux, typically do not provide real-time guarantees for processing. Rather, task processing is handled in such systems on an essentially priority interrupt driven basis. As an example, the arrival of a data packet in a receiving process generates a hardware interrupt. The hardware interrupt in turn causes the hardware to capture and stores data packets. A software interrupt mechanism, typically having a priority level that is lower than the hardware queuing process, performs receive protocol processing of the packets, to format them in a way that is acceptable for use by the application tasks. The application tasks then grab the packet from the system space for their own processing once they are scheduled to run.

While this priority interrupt-driven procedure involves a considerable amount of system level processing, there is little in the way of coordinating control of the different applications. In particular, lower level applications may be preempted by system level activities for processing the network packets. Moreover, this processing time in the system space is charged to the preempted process, which might not be the process that actually needs to eventually receive the received packets.

This arrangement leads to scheduling anomalies, priority inversion, and even overall decreased network throughput. In an extreme case, packets can arrive at a rate fast enough such that the system must spend all of its time serving the hardware interrupt process to grab and store the packets in the receive queue, but then finally dropping them when there are insufficient processor resources remaining to perform the protocol conversion function. Thus, all the inbound data is lost since the application is itself never scheduled to run.

Other operating systems such as VxWorks do allow for prioritization of tasks by an assigned priority level. When multiple tasks are pending, the task having the highest priority is selected and granted access first. The highest priority task is then allowed to run until it completes or enters a wait state. Once the higher priority task has been completed or is entering an idle state, the resource is then made available to a lower priority task.

This fixed priority scheme, while simple, also results in a number of difficulties. For example, if the higher priority state encounters a logical error condition, such as becoming stuck in an infinite processing loop, the controlling process will never finish the higher priority task. This has the effect of stalling or “crashing” the system.

Such a fixed priority scheme can work well in an instance in which the number of tasks is known in advance and the relative priorities can be determined, either analytically, empirically or through experimentation. However, in a more dynamic environment, where a new task may request access to the computing resources, there is the difficulty of assigning priorities for such new tasks. These will of course affect the running of lower priority processes if they are assigned a relatively highlevel priority. In turn, this can cause problems with legacy systems, requiring programmer intervention to re-assign process priorities.

For example, a given system may have been originally designed with a fixed-priority scheme and may work well in that mode. However, should it become desirable for the data processing system to perform new tasks, so that an additional process needs to be run so as to obtain throughput or timeliness guarantees, there then becomes a problem of reassigning priorities among the processes. This now typically requires intervention by the system designer in order to assure that system throughput remains at acceptable levels.

Another type of resource management approach involves a so-called “reservation system.” With this approach, available resources are assigned as a resource set, that comprise an essentially virtual operating system environment in which tasks run. The resource set defines a collection of data processing system resources that can be allocated for dedicated use by specific applications. The scheduling process then can assign each requesting task a certain fraction of the available resources during a particular time period, in effect making a “reservation” for that task to run in a guaranteed way.

For example, in the case of the network connection-servicing task, a reservation request may be made to reserve a certain percentage, such as 10 milliseconds (MS) of CPU time every 100 milliseconds available, and 2 mega-bits of the available access to a particular network connection every 250 milliseconds during recurring periodic intervals. An admission control process then arbitrates the request for a resource based on reservation requests received from multiple tasks running in the system.

The admission control process, or scheduling process, must ensure that the CPU or network-bandwidth needs of every resource set can be met on time. Hence, a scheduling policy may be implemented to determine which requesting task will be granted access to a particular resource at a particular time.

One certain policy is known as the so-called “deadline-monotonic scheduling” policy whereby the priority is assigned to a requesting process in an inverse proportion to a deadline associated by which a particular instance of a task must be completed. Other admission control policies can also be used, such as a so-called “rate-monotonic scheduling” policy, which assigns the priority of a process in an inverse proportion to its reservation period.

Another such policy is called “earliest deadline first” scheduling where the earliest absolute deadline of each currently active reservation is used to pick the highest priority task in the system. In this type of scheduling policy, the supervisory process assigns priority to a particular resource request if a condition can be satisfied such that a certain amount of resource access, C, can be provided within the certain amount of time, T, by a certain deadline time, D. The earliest deadline first scheduling policy thus seeks to satisfy an expression of the form

$${\sum }_{j = 1 }^{n } \frac{{C}_{j}}{{T}_{j}} \leq 1.0 ;$$

for the aggregate j processes; whereas the deadline-monotonic and rate-monotonic approaches seek to solve or satisfy the fixed-point equation:

$${a}_{n + 1} = {C}_{i} + {\sum }_{j = 1 }^{i = 1 } ⌈ \frac{{a}_{n}}{{T}_{j}} ⌉ {C}_{j} where {a}_{0} = {\sum }_{j = 1}^{i} {C}_{j}$$

Test terminates when aₙ>D₁ (not schedule)

or when aₙ₊₁=aₙ≦D₁ (schedule)

The deadline-monotonic and rate-monotonic scheduling policies are considered fixed- or static-priority schemes. The deadline-monotonic policy is also an optimum fixed-priority scheduling policy. In other words, priorities are assigned to processes such that they are granted access based upon a particular desired completion time, D. As a result, the shorter the time available to complete a task, the greater the priority of process will ultimately be assigned. The rate-monotonic scheduling policy is considered to be a special case of the deadline-monotonic scheduling policy with D=T. The earliest deadline first scheduling policy is considered to be a “dynamic-priority scheduling policy”, where the priority of a task can change from instance to instance. When priorities or deadlines are equal, ties can be broken arbitrarily, but are normally broken in first-come-first-served order. This leads to weighted round-robin schemes when the Ts of all tasks are chosen to be identical. As a result, throughput guarantees can be obtained.

Also, in traditional operating systems, time-sharing activities are normally scheduled as background-priority activities with an aging mechanism which allows non-critical tasks waiting long to be treated preferentially, and non-critical tasks executing a lot to be treated at low preference.

### SUMMARY OF THE INVENTION

The present invention relates to real-time scheduling of resources in a data processing system in which multiple tasks have different resource requirements. The multiple tasks must be scheduled to run concurrently; the tasks may typically be assigned to perform different activities. The present invention specifically seeks to provide guaranteed and timely processing for real-time applications that require or expect to be provided access to resources not only on a reservation basis, but also on a fixed-priority basis, running within the context of the same data processing system.

In connection with one aspect of the present invention, the tasks running in the system are prioritized on a reservation basis; other tasks are prioritized on a fixed priority basis. The reservation activities each have specified parameters for determining a priority allocation among other reservation activities. The reservation activities represent requests made by operating tasks for reservation of a certain capacity of a particular resource. In addition, fixed-priority activities are also allocated for in this same system. The fixed-priority activities each have a fixed-priority with respect to other fixed priority activities.

In connection with the present invention, the normal fixed-priority activities are collectively given a lower priority than at least one reservation activity. The end result is a system in which the fixed priority activities are never permitted to monopolize the available resources so that reservation activities may always be granted some access to the available resources. Critical activities are collectively given a higher priority than all reservation activities, such that their functions continue to behave as in a traditional operating system.

Not only are accommodations made for reservation-based activities as well as fixed priority activities in the hard reservation sense, but accommodation may also be made for possible soft reservations. In an instance where the available resource is not utilized 100% of the time, the designed consumption amount, C, has typically been met before expiration of a particular time period, T. Once this occurs, the process scheduler may enter a background mode whereby it may again assign the resource to a particular task prior to expiration of the period T.

In general, the invention therefore schedules reserved tasks such as may be controlled by an admission control process using a rate-monotonic or deadline-monotonic priority policy with a higher priority than fixed priority scheduled tasks such as may be defined by a simple priority scheme and/or a straight deadline monotonic admission control policy. Soft background tasks are then assigned a lower priority than either the reserved task or the fixed priority tasks such that they may run only when additional excess resource capacity is available.

These so-called soft reservation activities may, in addition, be scheduled at a background priority as a background activity after the reservation time has been consumed and the resource becomes available. However, this preferential class of soft activity is further assigned a preferential priority greater than at least one other background priority activity. As a result, the preferential soft activities, also called priority-reserved activities, are scheduled prior to the non-preferential background activities.

Another aspect of this invention is that tasks using a particular reservation can also be prioritized within the reservation. As a result, when a reservation is eligible to use the resource, the scheduling process chooses the highest priority activity bound to that reservation and eligible to execute on that resource. These priorities can be based on explicit fixed-priority values for non-periodic tasks or on deadline-monotonic or rate-monotonic policies for periodic tasks.

In connection with further aspects of the present invention, a resource kernel may be used to provide guaranteed access to resources for the reservation activities. The reservation activities may also be controlled through the use of resource sets defined within the context of a virtual machine. In particular, an operating system resource kernel may be defined that allocates a resource set representing a certain amount of available system resources to each particular task. The reservation activities may then be made for the resource sets by the tasks as a whole.

In connection with further aspects of the present invention, specified parameters for determining priority of the reservation activities may include resource consumption, C, a time period, T, associated with a scheduling process, and/or deadline time, D. Managed resources may include a number of data processing resources such as central processing unit (CPU) execution time, network bandwidth, disk access bandwidth, and/or other peripheral access bandwidths and/or times.

Yet other aspects of the present invention concern a default reserve allocation that may be made for the fixed-priority and background activities. In this manner, it can be known in advance that the fixed-priority and background activities will consume no more than a certain fraction of the available resources.

Another embodiment of the present invention may include a method for resource management in a data processing system such that multiple tasks having different resource requirements are scheduled to run concurrently with other tasks being assigned to different activities. In this implementation, a given reservation activity may have specified parameters for determining priority allocation among other reservation activities. However, a reservation activity itself may consist of a plurality of concurrent tasks executing within the single reservation activity. The collection of concurrent tasks may be collectively constrained by the parameters of the reservation activity itself.

In connection with yet another embodiment of the present invention, reservation activities may be assigned different priorities. As a result, one or more secondary level reservation activities, each having specified parameters for determining a reservation time based priority, may exist. The specified parameters for the secondary level activities will be collectively constrained by the specified parameters for the first-level reservation activity.

This concept of hierarchical reservation may be, of course, extended to two, three, or even a greater number of hierarchical reservation levels, with each lower-level reservation activity being constrained by the specified parameters for its associated higher-level activity.

It should also be understood that the critical activities, while given, may also be accommodated. Critical activities can include traditional operating system activities such as interrupt handlers and operating system processes. In this scenario, these critical activities may be granted a higher priority than the reservation activities. In an alternate scheme, a critical activity may be schedulable itself as a reservation activity. This approach provides for at least a guaranteed amount of the managed resource to be made available to any critical activity.

It should also be understood that reservation activities can also be scheduled at higher priority than normal activities using other traditional scheduling attributes such as dynamic priorities, such as those using the earliest deadline first policy.

In the special case where at most one task is bound to a reservation (or resource set), the attributes of the reservation can also be associated with the task directly.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a software system diagram showing a data processing system with a resource management process running that defines resource kernels and assigns priorities in a manner according to the present invention.

FIG. 2 is a general state diagram for a task.

FIG. 3 is a chart of priorities assigned by a scheduler process to tasks of different types, which is an example of a reservation model associated with the present invention.

FIG. 4 is a general state diagram of a reservation.

FIG. 5 is a diagram illustrating how a plurality of concurrent tasks may run within the context of a single reservation activity.

FIG. 6 illustrates how one or more secondary-level reservation activities may inherit properties such that they are constrained by specified parameters for higher-level reservation activities.

### DETAILED DESCRIPTION OF A PREFERRED EMBODIMENT

The present invention relates to the problem of data processing system resource management where multiple activities with different throughput and timing constraints must be scheduled concurrently. Task assignment to a particular resource must be shared among other tasks and must be globally managed in a real-time basis. A resource kernel model is ideally used to manage tasks in such a system to provide timely, guaranteed, and protected access to system resources. The resource kernel model allows applications to specify only their own resource demands, leaving the operating system kernel to satisfy those demands using even hidden resource management schemes. The tasks, therefore, may specify parameters for their associated resource kernel and the operating system kernel itself then enforces maximum resource usage by specific tasks. The resource management scheme may then be based upon a resource reservation model.

In addition, other tasks in the system may be granted access to resources on a strictly priority basis.

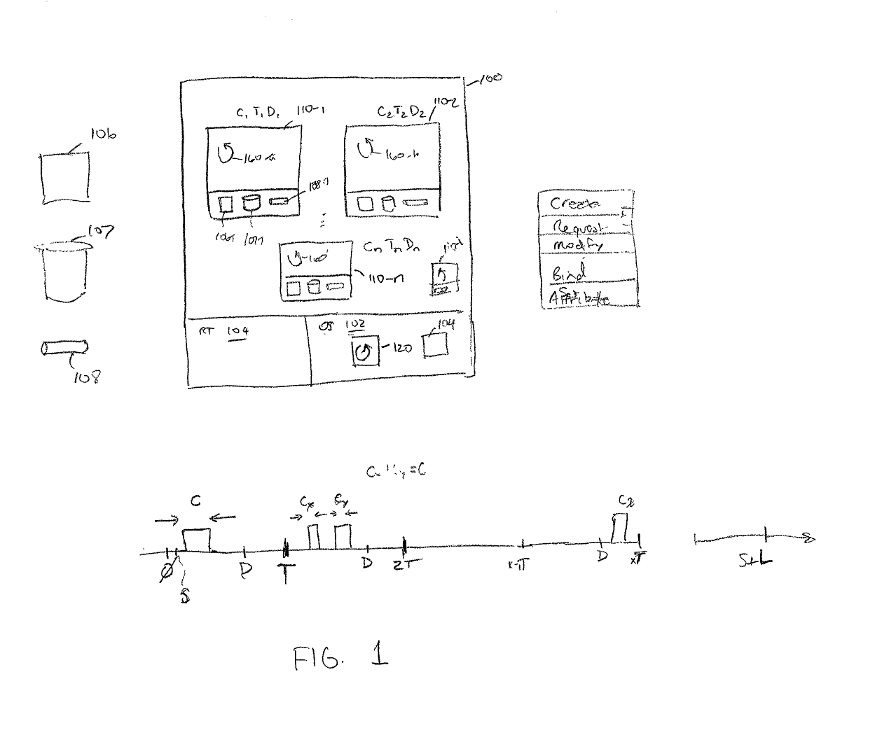

As shown in FIG. 1, the data processing system 100 is organized from a software perspective as being controlled by an operating system (OS) 102. The OS 102 may have associated with it real-time (RT) and throughput management functionalities in the preferred embodiment. A resource kernel 104 in the OS 102 provides a resource-centric approach for building the real-time control mechanism in the system to provide a timely, guaranteed, and enforced access to system resources.

Such system resources, for example, may consist of central processing unit (CPU) time, disk access bandwidth 107, network access bandwidth 108, or other data processing system resources which may include output devices including a serial bus and a parallel bus, virtual memory, array processor cycle time, and so forth. The resource kernel 104 provides system-level access to the multiple available resources.

A number of entities that are called resource sets 110 are associated with user-level processes in a particular way. From the point of view of user-level processes, a resource set 110 is an interface used to define a set of reservations in which a user processes or tasks have access to.

The resource kernel 104 allows a task to request a certain amount of access to a resource or, more specifically, a resource set 110. This implies that the kernel 104 supports an admission control policy for resource demands being made by the resource sets 110. The resource kernel 104 thus allows applications to specify their resource demands, leaving the kernel 104 to satisfy those demands using resource management schemes such as the scheduler 120 built into the operating system 102. The resource kernel 104 thus is the part of the OS 102 that is responsible for assigning, scheduling, and accounting for resources used by a task 160.

The key features of the resource kernel 104 include applying a uniform resource model for dynamic sharing of different resource types 106, 107, and 108; guaranteeing resource allocations at efficient time; and ensuring precise timing guarantees and temporal protection between applications by means of a well-defined resource usage model on time-multiplexed resources.

Application programs or tasks run within one or more resource sets 110 defined within the context of the operating system. Each resource set 104 provides a virtual operating system environment in which application tasks 160 run; the resource set 104 represents a set of data processing system resources that can be allocated for dedicated use by a specific task 160. A resource set 110 thus represents a set of reservations of various resource types 106, 107, 108. One or more executing programs or tasks 160 are associated with each resource set 110; the resource set 110 provides the exclusive use of a reserved amount of resource shares among those tasks 160.

One resource set 110-1, for example, has been granted a a certain number of CPU cycles 106-1 during every consecutive interval T1, a certain amount of disk bandwidth 107-1 during every consecutive interval T2, and a certain amount of network bandwidth 108-1 during every consecutive interval T3 as illustrated by the icons in the graphic depicting resource set 110-1. The resource set 110-1 in effect, can be thought of as representing a type of partitioned virtual machine in which one or more tasks or processes may execute. A resource set can also contain more than one reserve for the same resource.

The admission-control policy is administered by the scheduler process 120. The scheduler process 120 employs different types of prioritization schemes. The resource reservation model aspect of the scheduler uses a periodic task model that employs at least two parameters, including a maximum computation time, C, needed every periodic interval, T, for each activity that needs to be guaranteed. Thus, as shown in the time line, in a given interval from 0 through T, a certain amount of computation time C is allocated to the particular resource set 110-1.

An additional parameter for the reservation model may also employ not only the net utilization of the resource, i.e., the computation time C allocated every T time units, but also a deadline D by which the resource must be consumed. Thus, in the example of the time period from time 0 through T, the consumption time C is completed before the deadline D. It should be understood that the consumption may not be allocated in a continuous time frame by the scheduler 120. For example, in its second time period from time T through time 2T, the computation time is allocated in two portions, a first portion Cₓ and a second portion C_{y}. The sum of the times Cₓ plus C_{y} is equal to C so that the desired computation time has been completed before the deadline D. It should be understood that additional parameters for the resource allocation such as a start time S and life time L of the resource allocation may be defined. The parameters S and L therefore determine an overall time duration for the existence of the resource set 110-1.

The specified reservation parameters, including at least [C, T, and D] may be used as explicit parameters of the reservation model to be associated with each resource set. The semantics are such that each reservation be allocated at least C units of usage time every T units of absolute time. The C units of usage time will be guaranteed to be available for consumption before D units of time after the beginning of every periodic interval T. The guarantees start at absolute time at S and terminate at time S+L.

When a reservation uses up its allocation of C within an interval of time T, it is said to be depleted. A reservation which is not depleted is said to be an undepleted reservation. At the end of a duration T, the reservation will obtain a new quota of C and is said to be replenished. Such replenishment can occur T time-units from the previous replenishment or from previous resource usage(s). In the reservation model, the behavior of a reservation between depletion and replenishment can take one of three forms.

Hard reservations upon depletion cannot be scheduled until they are replenished. In other words, a hard reservation represents a resource reservation that will only consume a maximum of C units within a given time period T. While this appears to be wasteful, i.e., the time between D and the end of each interval T is not being utilized at all, this type of reservation can act as a building block model for implementing virtual resources.

A firm reservation upon depletion can be scheduled for execution only if no other undepleted reservation or unreserved threads are ready to run.

Finally, a soft reservation upon depletion can be scheduled for execution, along with other unreserved threads and/or depleted reservations. In effect, the soft reservations may then run in a time between the time D and the end of a reservation period T. As shown in the time line, a consumption time Z can be allocated during this time period associated between D and T for such soft reservations.

A system-call interface may be used by the tasks to invoke upon a request for reservation of a resource. The reservation call interface may include a create, request, modify, bind, set attribute, and other system calls. In particular, the create and request system calls can be used to initiate a reservation and then in turn request a resource on the particular reservation. A modify system call can be used to modify current reservation parameters for the particular resource set 110. Most importantly, the set attribute system call may be used to set the attributes of a reservation in order to define it as a hard, firm, or soft reservation. The bind system call can be used to bind a particular thread 160 to a given reservation made by a resource set 110-1.

The scheduler also supports resource requests that are allocated a fixed-priority attribute. Such processes are given access to the available resources on a fixed priority, potentially interrupt-driven basis, as is common in traditional multitasking operating systems such as Linux.

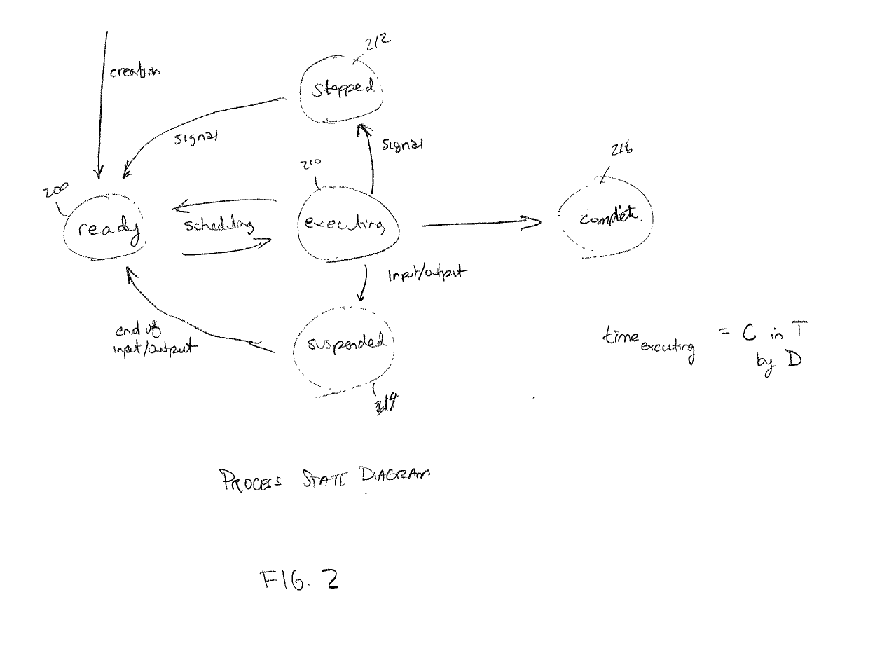

FIG. 2 is a canonical diagram for a given process 160. As can be seen upon creation of the process it first enters a ready state 200. Upon receiving a signal from the scheduler process 102, the task 160 will enter an executing state 210. The process remains in this executing state 210 until a signal is received that either stops the process causing it to enter a state 212, or enter a suspended state 214. In the event of entering a stopped state 212, upon receipt of an additional signal such as from an external peripheral or from the kernel 104, the process will again enter the ready state 200. From the suspended state 214, process may, for example, receive an end of an I/O operation indication and again return the ready state. The executing state 210, upon receiving an input or output indication, may then such as receiving a data byte, may then enter a suspended state 214. Upon the end of the execution state 210, the process enters a completed or ‘zombie’ state 216 in which it will execute no further until restarted. The constraint associated with the parameters of the resource reservation model are such that the time spent during the executing state 210 is equal to C and every time T periods of time and that the execution time C is completed by time D.

The resource scheduler can operate correctly given the parameters C, D, and T, for a set of processes 160 within the context of each of the resource sets 110, assuming that the collective aggregation of all the processes 160 running within all of the resource sets 110 do not exceed more than 100% of any resource. However, in complicated operating systems in which, for example, more than one resource set is allocated concurrently, it is entirely possible that it becomes a case that reservations have been made for more than 100% of the resources. In such an instance, the scheduler process 120 must therefore prioritize among the requesting resource sets 110.

As explained above, other processes may need to be handled in the same manner as in a legacy application by assigning priorities among multiple such tasks on a strict fixed-value basis. For example, a certain task 160-a may be a hardware-serving task that inherently needs to have a greater priority than another task 160-b that is a software-only process. In such systems, the higher priority task 160-a will run until it either enters the completion state 216, or a stopped or suspended state 212, 214. Only in this instance would the resource then be released for execution for use by a lower priority process.

The resource reservation model in accordance with the present invention attempts to accommodate such a legacy system in a manner that provides for minimal disruption of the existing legacy fixed priority schemes, as well as for providing for a reservation-based model described above.

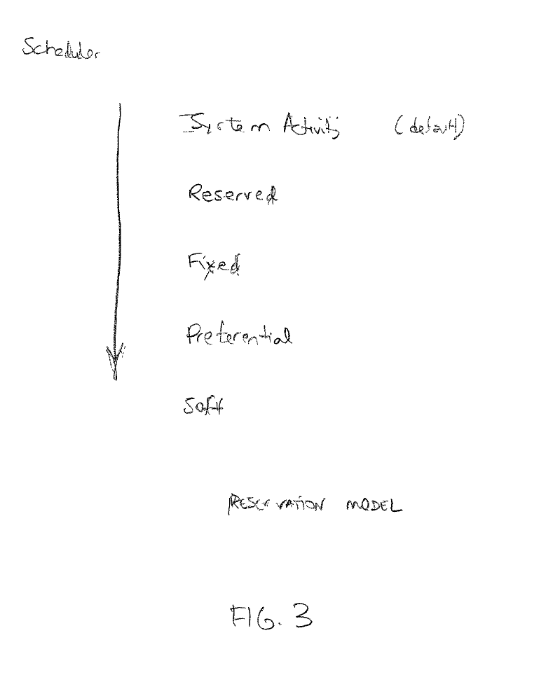

FIG. 3 is a general diagram of a reservation model implemented in accordance with the present invention by the scheduler process 120. In particular, the scheduler assigns priorities to fixed-priority tasks with a lower level than those having a reserved priority attribute. For example, a task having an attribute of reserved will have at least the C, T, and D parameters associated with it. However, other tasks that are designated with attribute fixed-priority task may have an attribute that is only a relative priority designation. In effect, the reservation model guarantees a higher overall priority be allocated to those tasks given a reserved attribute as opposed to those tasks having the fixed priority attribute. In addition, the reservation model provides for granting lower priority to tasks as soft reservation tasks, as described below.

In the preferred embodiment, the overall reservation scheme employs a fixed priority scheme to efficiently support legacy fixed priority scheduling. In other words, even reservation tasks are assigned a fixed priority which is equal to its period, T, or deadline, D, depending upon whether a rate-monotonic or deadline-monotonic scheme, is used respectively.

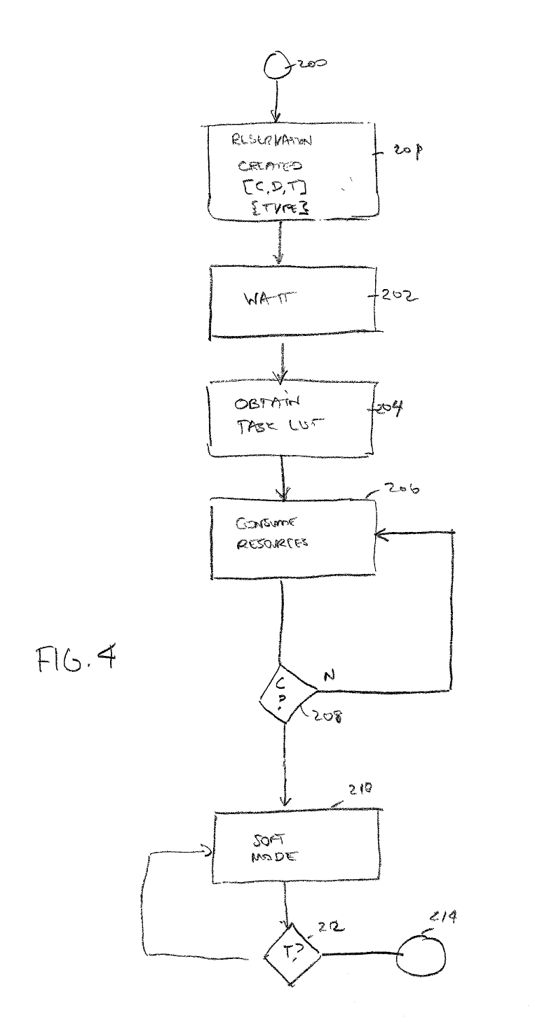

In the preferred embodiment, the deadline-monotonic model is selected. In this manner, the fixed-priority tasks are granted access to the available resources but will be preempted by reserved tasks. Thus, reservation tasks will always be granted their expected guaranteed access times. There is also a class of soft or background tasks that may be associated with preferential treatment. As such, these tasks may be given an attribute of ‘preferred’. The preferred tasks will be run before tasks having only the soft attribute. Multiple tasks can be bound to a resource set and can therefore contend for the same reservation inside the resource set. FIG. 4 is a state diagram illustrating the steps in which the resource kernel 104 performs to process reservation requests. In a first state, the reservation is idle. However, at state 201, the reservation has been created. In this state, minimum parameters for the reservation, such as C, D, and T, have been specified. The creator of the reservation may also have provided information concerning the type of desired reservation such as specifying system activity, reserved, fixed, preferential, and/or soft state as defined by the reservation model of FIG. 3.

Once a reservation has been created, a state 202 is entered in which the reservation waits for a time to become active. For example, the scheduler may determine that certain reservations are to be scheduled at different times. Upon being activated, state 204 is entered in which a task list associated with the reservation is obtained. This list would, for example, consist of this particular set of tasks 160 associated with a particular reservation and resource set 110.

The reservation then begins to execute and consume resources in state 206. This continues until a time C is consumed. The test for consumption of the assigned amount of time C can be performed in state 208.

Upon expiration of the time C, a soft mode is entered in state 210. In this mode, if the types of resources are appropriate, this “soft mode” can be used to execute the so-called soft assigned tasks.

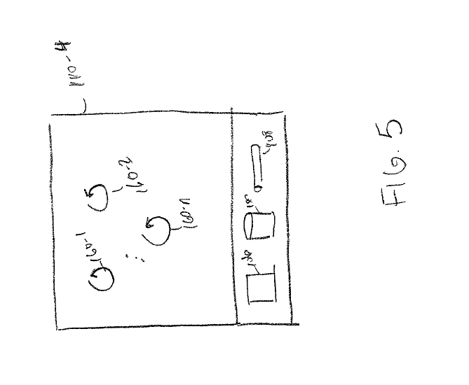

Finally, in state 212, a time T is reached at which point the idle state 214 is again entered. FIG. 5 is a more-detailed diagram of a particular resource set 110-4 having a number of tasks 160-1, 160-2, 160-n associated with it. The diagram is meant to illustrate that a number of different tasks can be running within the context of a single resource set 110-4 and that those tasks themselves may be assigned a priority among themselves. Thus, for example, the resource set 110-4 may be initially assigned as a reservation task using a certain amount of the available CPU cycles 106, disk bandwidth 107, and network access bandwidth 108. This can be requested as a resource allocation with the attribute reservation. However, the tasks themselves 160-1, 160-2, . . . , 160-n running within the context of the single resource set 110-4 may then be assigned with attributes as fixed-priority tasks.

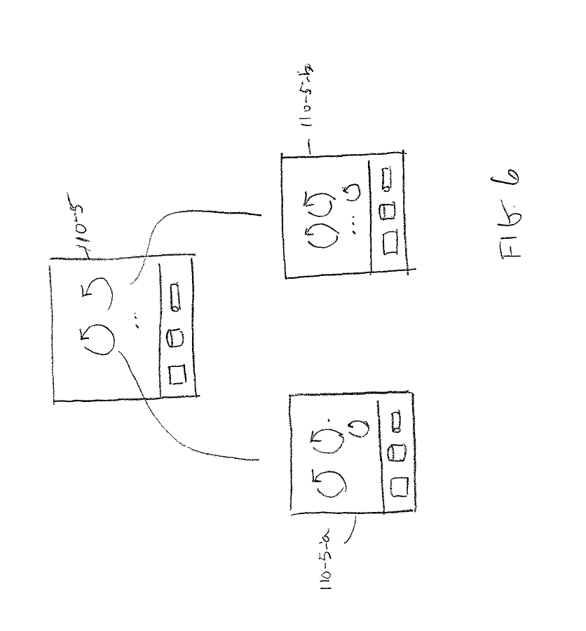

FIG. 6 illustrates a concept of attribute inheritance for resource sets. In this example, a resource set 110-5 is associated with it two descendant or second-tier resource sets 110-5-a and 110-5-b. The resource sets 110-5-a and 110-5-b each are a reservation of a certain amount of the resources originally requested by the higher layer resource set 110-5. So, for example, the reservation attributes of resource sets 110-5-a and 110-5-b collectively add up to something less than the reservation request represented by resource set 110-5. This provides for reservation activities to be scheduled within the context of a parent reservation activity with the collection of concurrent tasks 160, all running within the context of the resource sets 110-5-a and 110-5-b, all satisfying the resource parameters of the parent resource set 110-5.

There may be certain default parameters associated with activities that are not aware of, or do not want to use, the reservation interface. The execution of such activities will be “charged” to a default resource set (or reservation) that is pre-defined in the operating system 102. Reservations in this default resource set will have lower priority than those in resource sets explicitly created by activities.

An idle reserve resource set 110-i may also be defined within the context of the system 100. The other reserve set 110-i may be assigned a task that is running during resource idle time. This provides a mechanism for the scheduler 120 to charge the non-usage of particular resources during resource idle time.

The model has a number of advantages that are not associated with systems known in the prior art. For example, legacy applications may have been implemented in the past using simple fixed-priority (or dynamic-priority?) schemes. The invention provides a mechanism for supporting such fixed-priority schemes within the context of a reservation system.

For example, a resource set 110-1 may be associated with the legacy fixed-priority tasks. The tasks then, therefore, need not be rewritten or re-engineered by application developers in order for them to behave as they have in the past in the legacy application. However, by constraining the implementation of the legacy fixed-priority task to within the context of one or more resource sets, or at lower priority than resource sets, newer applications may be implemented in a reservation model taking advantage of the reservation model's attributes.

What is claimed is:

1. A method for resource management in a data processing system in which multiple tasks with different requirements are scheduled to run concurrently, the tasks being assigned to different data processing activities, the method comprising the steps of:
allocating resource accesses on a reservation activity basis, each such reservation having specified parameters for determining a priority allocation among other reservation activities;
allocating other resource accesses as fixed priority activities, the fixed priority activities each having a priority value with respect to other fixed priority activities; and
wherein the fixed priority activities are given a lower priority than at least one of the reservation activities.

2. A method as in claim 1 in which the data processing system is a real-time system.

3. A method as in claim 1 wherein the different requirements are time constraints.

4. A method as in claim 1 wherein the different requirements are data processing resource requirements.

5. A method as in claim 1 wherein the specified parameters for determining priority are reservation time-based parameters.

6. A method as in claim 5 wherein the specified parameters for the reservation based priority allocation are selected from a group consisting of resource consumption time C, time period T, and deadline D.

7. A method as in claim 1 additionally comprising the step of:
operating a resource kernel to provide guaranteed and timely access to requirements for the reservation activities.

8. A method as in claim 1 wherein the reservation activities are selected from a group consisting of resource sets, tasks, and reservations.

9. A method as in claim 4 wherein the resource is selected from a group consisting of central processing unit cycles, network bandwidth, disk access bandwidth, input device bandwidth, and output device bandwidth.

10. A method as in claim 1 wherein a default reservation activity is allocated to the fixed-priority and background-priority activities collectively.

11. A method for resource management in a data processing system in which multiple tasks with different requirements are scheduled to run concurrently, the tasks being assigned to different data processing system activities, comprising the steps of:
making allocations for the execution of reservation activities, each reservation activity having specified parameters for determining priority allocation among other reservation activities;
making allocations for the execution of a plurality of concurrent tasks running within a single reservation activity; and
such that the aggregation of concurrent tasks are collectively constrained by the parameters of the reservation activity.

12. A method as in claim 11 wherein the data processing system is a real-time operating system.

13. A method as in claim 11 wherein the different requirements are time constraints.

14. A method as in claim 11 wherein the different requirements are resource requirements.

15. A method as in claim 11 additionally comprising the step of:
operating a resource kernel to provide guaranteed access to resources for the reservation activities.

16. A method as in claim 11 wherein the reservation activities are selected from a group consisting of resource sets, tasks, and reservations.

17. A method as in claim 11 wherein the specified parameters for a reservation activity are resource consumption C, time period T, and deadline D.

18. A method as in claim 14 wherein the resource is selected from a group consisting of central processing unit time, network bandwidth, disk access bandwidth, input device bandwidth, and output device bandwidth.

19. A method for resource management in a data processing system in which multiple tasks are scheduled to run concurrently, the tasks being assigned to different data processing system activities, comprising the steps of:
executing a first-level reservation activity, the reservation activity having specified parameters for determining priority allocation among other reservation activities; and
executing one or more secondary-level reservation activities, each having specified parameters for determining a reservation time-based priority, the specified parameters for the secondary-level activities collectively constrained by their associated specified parameters for their associated first-level reservation activity.

20. A method as in claim 19 wherein the secondary-level reservation activities are themselves composed of further hierarchical level activities encompassing at least a third tertiary-level reservation activity.

21. A method for resource management in a data processing system in which multiple tasks are scheduled to run concurrently, the tasks being assigned to different data processing system activities comprising the steps of:
allocating reservation activities, each having specified parameters for determining a reservation time-based priority allocation among other reservation activities;
scheduling the reservation activity as a background activity after the reservation time has been consumed should the specified resource become available; and
such that the background activity may be further assigned a preferential priority.

22. A method as in claim 21 additionally comprising wherein the background activity may be further assigned a preferential priority such that background activities having a preferential priority are scheduled before those having a non-preferential background activity priority assignments.

23. A method for resource management in a data processing system in which multiple tasks with different time constraints and/or resource requirements are scheduled to run concurrently, the tasks being assigned to different data processing system activities, comprising the steps of:
providing for the execution of reservation activities, each having specified parameters for determining a reservation time-based priority allocation among other reservation activities; and
providing for the executing of one or more system level activities, having at least one critical activity having a priority higher than the reservation activities.

24. A method for resource management in a data processing system in which multiple tasks with different time constraints and/or resource requirements are scheduled to run concurrently, the tasks being assigned to different data processing system activities, comprising the steps of:
providing for the execution of reservation activities, each having specified parameters for determining a reservation time-based priority allocation among other reservation activities; and
providing for the execution of one or more critical system activities, schedulable themselves as a reservation activity.

25. A method for resource management in a data processing system in which multiple tasks with different requirements are scheduled to run concurrently, the tasks being assigned to different data processing activities, the method comprising the steps of:
allocating resource accesses on a reservation activity basis, each such reservation having specified parameters for determining a priority allocation among other reservation activities;
allocating other resource accesses as dynamic priority activities, the dynamic priority activities each having a priority value with respect to other dynamic priority activities; and
wherein the dynamic priority activities are given a lower priority than at least one of the reservation activities.

26. A method as in claim 25 in which the data processing system is a real-time system.

27. A method as in claim 25 wherein the different requirements are time constraints.

28. A method as in claim 25 wherein the different requirements are data processing resource requirements.

29. A method as in claim 25 wherein the specified parameters for determining priority are reservation time-based parameters.

30. A method as in claim 25 wherein the specified parameters for the reservation based priority allocation are selected from a group consisting of resource consumption time C, time period T, and deadline D.

31. A method as in claim 25 additionally comprising the step of:
operating a resource kernel to provide guaranteed and timely access to requirements for the reservation activities.

32. A method as in claim 25 wherein the reservation activities are selected from a group consisting of resource sets, tasks, and reservations.

33. A method as in claim 25 wherein the resource is selected from a group consisting of central processing unit cycles, network bandwidth, disk access bandwidth, input device bandwidth, and output device bandwidth.

34. A method as in claim 25 wherein a default reservation activity is allocated to the dynamic-priority and background-priority activities collectively.
